(19) United States
(12) Patent Application Publication
(10) Pub. No.: US 2023/0408639 A1
(43) Pub. Date: Dec. 21, 2023

(54) RECEIVED-SIGNAL PROCESSING APPARATUS OF A DETECTION DEVICE FOR MONITORING AT LEAST ONE MONITORING REGION, DETECTION DEVICE AND METHOD FOR OPERATING A DETECTION DEVICE

(71) Applicant: Valeo Schalter und Sensoren GmbH, Bietigheim-Bissingen (DE)

(72) Inventors: Christoph Parl, Bietigheim-Bissingen (DE); Thomas Schuler, Bietigheim-Bissingen (DE); Wensi Zheng, Bietigheim-Bissingen (DE)

(73) Assignee: Valeo Schalter und Sensoren GmbH, Bietigheim-Bissingen (DE)

(21) Appl. No.: 18/254,011

(22) PCT Filed: Nov. 17, 2021
(86) PCT No.: PCT/EP2021/081946

§ 371 Date: May 23, 2023

(30) Foreign Application Priority Data
Nov. 23, 2020 (DE) 10 2020 130 881.7

(51) Int. Cl. G01S 7/35; G01S 7/493; G01S 13/931

(52) U.S. Cl. CPC G01S 7/354; G01S 7/493; G01S 13/931; G01S 2013/9323

(57) ABSTRACT

A received-signal processing apparatus of a detection device for monitoring at least one monitoring region for objects by means of electromagnetic scanning signals is disclosed. The received-signal processing apparatus has at least one frequency analysis means for the frequency analysis of electromagnetic received signals, which are determined from echo signals of electromagnetic scanning signals reflected in at least one monitoring region. The received-signal processing apparatus has a plurality of functionally parallel frequency filters having at least partially different frequency passbands. At least one frequency filter has at least one frequency labeling means, by which the passed received signal can be labeled with a frequency characteristic which characterizes the frequency passband of the at least one passage-allowing frequency filter.

### TECHNICAL FIELD

The invention relates to a received-signal processing apparatus of a detection device for monitoring at least one monitoring region for objects by means of electromagnetic scanning signals, wherein the received-signal processing apparatus has at least one frequency analysis means for the frequency analysis of electromagnetic received signals, which are determined from echo signals of electromagnetic scanning signals reflected in at least one monitoring region.

The invention further relates to a detection device for monitoring at least one monitoring region for objects by means of electromagnetic scanning signals, having at least one transmitting device, by means of which electromagnetic scanning signals can be generated from electrical transmitted signals, wherein said scanning signals can be transmitted into at least one monitoring region, having at least one receiving device, by means of which electrical received signals can be determined from echo signals of electromagnetic scanning signals reflected in at least one monitoring region, and having at least one control and evaluation device, which comprises at least one frequency analysis means for the frequency analysis of the electrical received signals.

In addition, the invention relates to a method for operating a detection device for monitoring at least one monitoring region, in which method electromagnetic scanning signals are generated from electrical transmitted signals and transmitted into at least one monitoring region, electrical received signals are determined from echo signals of electromagnetic scanning signals reflected in at least one monitoring region, at least one frequency analysis is performed on the electrical received signals and on the basis of at least one frequency analysis, information on the at least one monitoring region is determined.

### PRIOR ART

Document US 2019/0370614 A1 discloses a high-resolution LIDAR system. A laser source emits a carrier wave that is amplitude-, frequency-, or phase-modulated in the modulator, or modulated in a combination, to generate a pulse that has a bandwidth and period. A splitter divides the chirp into a transmit beam with the majority of the beam energy and a reference beam with a much lower amount of energy, but which is sufficient to produce a good heterodyne or homodyne interference with the light scattered back from a target. Multiple parts of the target scatter a respective reflected light signal back to the detector array for each scanned beam, resulting in a point cloud based on the multiple distances of each of the multiple parts of the target that are illuminated by multiple beams and multiple return paths. A de-chirp mixer compares a detected signal to the original chirp waveform output by the power splitter and operational amplifier in order to generate an electrical signal at the beat frequency that depends on the frequency difference between the RF reference waveform and the detected waveform. An additional operational amplifier and an FFT process are used to determine the beat frequency.

The object of the invention is to design a received-signal processing apparatus, a detection device, and a method of the type mentioned in the introduction, with which a frequency analysis of the electrical received signals can be implemented more easily.

### DISCLOSURE OF THE INVENTION

This object is achieved according to the invention in the case of the received-signal processing apparatus by the fact that the received-signal processing apparatus has a plurality of functionally parallel frequency filters with at least partially different frequency passbands
and at least one frequency filter has at least one frequency labeling means, by means of which the passed received signal that is passed through said at least one frequency filter can be labeled with a frequency feature that characterizes the frequency passband of the at least one frequency filter that passes it.

According to the invention, a plurality of frequency filters with different frequency passbands is provided, with which the electrical received signals are analyzed with regard to their frequency.

In addition, at least one frequency filter has a frequency labeling means, with which the passed received signal passed through said at least one frequency filter is provided with a corresponding frequency feature. The individual frequency feature characterizes the corresponding at least one frequency filter. Using the frequency labeling means, the passed received signal can be assigned to the at least one frequency filter through which it is passed, and thus to the frequency passband thereof. In this way, the frequencies that make up the corresponding received signal can be analyzed. This does not require any prior transformation in the usual sense, which requires complex components and a comparatively high energy consumption, particularly in multi-channel systems.

By means of the received-signal processing apparatus according to the invention, a frequency analysis of the electrical received signals can also be carried out for multi-channel systems using simple components. Frequency filters with frequency labeling means can be easily designed and implemented. This also allows an energy-efficient frequency analysis to be carried out. In addition, received-signal processing apparatuses according to the invention can be implemented in a compact manner.

The frequency passband of a frequency filter is the frequency range between a lower cutoff frequency and an upper cutoff frequency. The cutoff frequencies characterize the respective frequency filter.

Advantageously, the frequency ranges of the frequency passbands can be predefined such that a desired distance resolution can be achieved for a desired range of the detection device in conjunction with the frequency response of the scanning signals.

Advantageously, electromagnetic scanning signals in the form of frequency-modulated continuous wave (FMCW) signals can be used with the at least one detection device. In this way, distances of objects can be determined on the basis of frequency shifts between scanning signals and scanning signals reflected as echo signals. In the case of frequency-modulated continuous wave signals, signal sequences, in particular in the form of chirps, can be transmitted continuously. Accordingly, the electrical transmitted signals from which the electromagnetic scanning signals are generated, in particular by means of a transmitting device, can be frequency-modulated continuous wave signals.

The electromagnetic scanning signals can be light signals, radar signals or the like. For the purpose of generating the electromagnetic scanning signals from electrical transmitted signals, the detection device, in particular a transmitting device of the detection device, can comprise at least one light source, in particular at least one laser, or at least one radar antenna, depending on the type of scanning signals. Accordingly, for converting the echo signals of the reflected electromagnetic scanning signals into electrical received signals, the detection device, in particular a receiving device of the detection device, can comprise at least one light receiver or at least one radar antenna, depending on the type of scanning signals.

Detectors designed for the wavelength of the emitted scanning signals, in particular point sensors, line sensors and/or area sensors, in particular (avalanche) photodiodes, photodiode lines, CCD sensors, active pixel sensors, in particular CMOS sensors, or the like are used as light receivers.

The received-signal processing apparatus according to the invention can be used to extract maxima from a frequency spectrum of the electrical received signals using at least one frequency analysis. On the basis of at least one frequency analysis, information about the at least one monitoring region, in particular object information of objects in the at least one monitoring region, can be determined. The information about the at least one monitoring region can be object information in the form of distances, speeds and/or directions of objects relative to the detection device, at which the scanning signals are reflected.

Advantageously, the at least one detection device can be designed as light-detection-and-ranging systems (LiDAR), laser-detection-and-ranging systems (LaDAR), radar systems or the like. These types of detection devices allow the distances, speeds and/or directions of objects relative to the detection device to be determined.

Advantageously, the at least one detection device can be designed as a scanning system, in particular a scanning LiDAR system, or as a flash system, in particular Flash LiDAR. In a scanning system, a monitoring region can be sampled, that is to say scanned, with scanning signals. In a flash system, corresponding scanning signals can simultaneously irradiate a major portion of the monitoring region or the entire monitoring region.

The invention can advantageously be used in vehicles, in particular motor vehicles. The invention can advantageously be used in land-based vehicles, in particular automobiles, trucks, buses, motorcycles or the like, aircraft, in particular drones, and/or watercraft. The invention may also be used in vehicles that may be operated autonomously or at least semiautonomously. However, the invention is not restricted to vehicles. It can also be used in a stationary scenario, in robotics and/or in machines, in particular construction or transport machinery, such as cranes, excavators or the like.

The detection device can advantageously be connected to at least one electronic control device of a vehicle or machine, in particular a driver assistance system, or can be part of such a control device. In this way, at least a part of the functions of the vehicle or the machine can be operated autonomously or partially autonomously.

The detection device can be used to detect stationary or moving objects, in particular vehicles, persons, animals, plants, obstacles, roadway irregularities, in particular potholes or rocks, roadway boundaries, traffic signs, free spaces, in particular free parking spaces, or precipitation or the like.

In one advantageous embodiment, at least one frequency filter can be a bandpass filter. Bandpass filters can be configured with individual frequency passbands.

At least one frequency filter, in particular a bandpass filter, can advantageously be realized as a resonant circuit. Simple bandpass filters can be implemented with resonant circuits. A resonant circuit is characterized by a lower cutoff frequency, an upper cutoff frequency, and a resonance frequency that lies between the lower cutoff frequency and the upper cutoff frequency. The frequency passband of the resonant circuit can be characterized by these parameters.

In addition, bandpass filters can be implemented with individual gains. The individual gain of a bandpass filter can be used as a frequency labeling means, with which a passed received signal can be labeled in relation to the frequency passband of the bandpass filter.

In a further advantageous embodiment, the frequency passbands of at least two frequency filters adjacent in frequency may at least partially overlap and/or the frequency passbands of at least two frequency filters adjacent in frequency cannot overlap.

With at least partially overlapping frequency passbands, a larger frequency range can be covered without gaps.

With at least partially overlapping frequency passbands, mixtures of different frequency filters can also be resolved.

With overlapping frequency passbands, if received signals are passed by two frequency filters adjacent in terms of their frequency passbands, it can be assumed that the frequency of the passed received signal is in the overlap range of the frequency passbands. The frequency of the passed received signal can thus be determined more accurately.

The use of non-overlapping frequency passbands can reduce the number of frequency filters required to cover the maximum frequency amplitude of the electrical input signal.

In a further advantageous embodiment, the frequency passbands of the frequency filters in total can cover the maximum frequency amplitude of the electrical received signals. In this way, the received signals can be analyzed over the entire frequency amplitude range.

In a further advantageous embodiment, at least two frequency filters can have frequency passbands with the same frequency range and/or at least two frequency filters can have frequency passbands with different frequency ranges. In this way, the received-signal processing apparatus can be adapted in a more flexible way to suit the application.

Frequency filters with the same frequency ranges can be used to analyze electrical received signals in terms of their frequency with uniform frequency segments.

Different frequency ranges can be used to adapt the resolution capability of the received-signal processing apparatus with respect to the frequency analysis to different distance ranges for objects. In particular, a deterioration of the distance resolution, caused by the distance of a reflecting object from the detection device, can be counteracted by appropriate adjustment of the frequency passbands.

In a further advantageous embodiment, at least one of the frequency filters can have an individually defined electrical gain as a frequency-labeling means. Using the defined electrical gain, the passed received signal that is passed through can be individually amplified relative to the frequency filter. The individual degree of gain of the passed received signal can in this case form a frequency feature for the passed received signal, which characterizes the frequency passband of the corresponding frequency filter that passes it. In this way, the passed received signal can be assigned to the appropriate frequency filter through which it was passed via the electrical gain. Since each frequency filter has an individual frequency passband, the passed received signal can be assigned to the frequency passband and thus its frequency can be analyzed.

Advantageously, each frequency filter can have an individually defined electrical gain as a frequency labeling means. In this way, all frequency filters can be distinguished from one another.

In a further advantageous embodiment, the received-signal processing apparatus can have at least one normalization means for normalizing the received signals. This allows dependencies of the amplitudes of the received signals on the distances of reflecting objects from the detection device to be compensated. The received signals can be normalized in terms of their amplitude.

In a further advantageous embodiment, at least one normalization means can comprise at least one amplifier stage. An amplifier stage can be used to directly subtract the amplitude of a corresponding received signal from the amplitude of the corresponding passed received signal that is passed through the filter.

In a further advantageous embodiment, at least one normalization means of the received-signal processing apparatus may have at least one operational amplifier, of which one of the inputs is connected to the outputs of the frequency filters and another of the inputs is connected to the inputs of the frequency filters. Operational amplifiers can be implemented in a space-saving and energy-efficient manner. Operational amplifiers can be used to subtract the signal amplitude of the received signal present at the inputs of the frequency filter from the signal amplitude of the passed received signal present at the outputs of the frequency filters.

In a further advantageous embodiment, at least one resistor arrangement can be arranged between an input of at least one operational amplifier of a normalizing means of the received-signal processing apparatus and the inputs of the frequency filters. In this way, the at least one operational amplifier can be used to implement a kind of subtracter for the received signal and the passed received signal.

In a further advantageous embodiment, the received-signal processing apparatus can have at least one delay means, which is directly or indirectly connected to the outputs of the frequency filters and/or directly or indirectly connected to at least one input of at least one normalization means of the received-signal processing apparatus. This allows the passed received signal to be delayed. Thus, further processing of the at least one passed-through received signal can be carried out more energy-efficiently. In addition, multiplexing and/or digitization with frequency bandwidths in high frequency ranges can be enabled, in particular in the kilohertz range. The at least one delay means can advantageously have an integrating component for this purpose.

In a further advantageous embodiment, at least one delay means of the at least one received-signal processing apparatus can have at least one electrical capacitance. An integrating component can be implemented with an electrical capacitance. In this way, multiplexing and digitization of the passed received signals in high frequency ranges can be enabled, in particular in the kilohertz range.

In a further advantageous embodiment, at least one delay means of the received-signal processing apparatus can be functionally arranged between at least one input and at least one output of the at least one normalization means of the received-signal processing apparatus. In this way, feedback can be applied to the at least one normalization means with the at least one delay means. In this way, overall the received signal that is passed through the filter can be further delayed.

The object according to the invention is furthermore achieved in the case of the detection device by the fact that at least one received-signal processing apparatus has a plurality of functionally parallel frequency filters with at least partially different frequency passbands
and at least one frequency filter has at least one frequency labeling means, by means of which the passed received signal that is passed through said at least one frequency filter can be labeled with a frequency feature that characterizes the frequency passband of the at least one frequency filter that passes it.

Advantageously, at least one control and evaluation device can have at least one evaluation means for determining information about the at least one monitoring region, in particular for determining object information such as distance, speed and/or direction of an object relative to the detection device, on the basis of at least one frequency analysis. In this way, the corresponding information about the monitoring region can be determined with the detection device itself.

Advantageously, the at least one control and evaluation device can have at least one signal generating means for generating electrical transmitted signals. At least one transmitting device for emitting electromagnetic scanning signals can be controlled with the electrical transmitted signals.

Advantageously, the detection device can have at least one frequency comparison means, which can be used to form frequency differences between a frequency of an electrical transmitted signal and a passed received signal, detected with the received-signal processing apparatus. In this way, a distance and/or a speed of a detected object relative to the detection device can be determined from the frequency difference.

In addition, the object according to the invention is achieved in the case of the method by the fact that at least one received signal is supplied to a plurality of functionally parallel frequency filters with at least partially different frequency passbands and the passed received signal that is passed by at least one frequency filter is labeled with a frequency feature, which characterizes the frequency passband of the at least one frequency filter that passes it.

According to the invention, the at least one received signal is only passed by the frequency filters, the frequency passbands of which include the frequency of the at least one received signal. If the frequency passbands of frequency filters adjacent in frequency overlap, the at least one received signal, provided that its frequency is located in the overlap range of the two frequency passbands, can also be passed by both frequency filters. By means of individual frequency labeling means of the frequency filters, the passed-through received signal is labeled with individual frequency features. By means of the frequency features, the at least one received signal is assigned in a frequency-dependent manner to at least one of the defined frequency filters and thus analyzed with respect to frequency.

In other respects, the features and advantages indicated in connection with the received-signal processing apparatus according to the invention, the detection device according to the invention and the method according to the invention and the respective advantageous configurations thereof apply in a mutually corresponding manner and vice versa. The individual features and advantages may of course be combined with one another, wherein further advantageous effects that go beyond the sum of the individual effects may emerge.

### BRIEF DESCRIPTION OF THE DRAWINGS

Further advantages, features and details of the invention will become apparent from the following description, in which exemplary embodiments of the invention are explained in greater detail with reference to the drawing. A person skilled in the art will expediently also consider individually the features that have been disclosed in combination in the drawing, the description and the claims and will combine them to form meaningful further combinations. Schematically, in the figures,

FIG. 1 shows a front view of a motor vehicle having a driver assistance system and a LiDAR system for monitoring a monitored region in front of the motor vehicle in the direction of travel;

FIG. 2 shows a functional illustration of the vehicle with the driver assistance system and the LiDAR system from FIG. 1;

FIG. 3 shows a functional illustration of a received-signal processing apparatus of the LiDAR system from FIGS. 1 and 2;

FIG. 4 shows a power-time diagram of an electrical transmitted signal in the form of a frequency-modulated continuous wave signal of the LiDAR system from FIGS. 1 and 2, from which an electromagnetic scanning is generated for monitoring the monitoring region;

FIG. 5 shows a frequency-time diagram of the electrical transmitted signal from FIG. 4 and of an electrical received signal which is determined from an echo signal of the electromagnetic scanning signal;

FIG. 6 shows an excerpt of the frequency-time diagram from FIG. 5, in which a transmitted chirp of the electrical transmitted signal and a corresponding received chirp of the electrical received signal are shown, wherein respective frequency passbands of frequency filters of the received-signal processing apparatus of the LiDAR system from FIGS. 1 to 3 are marked on the frequency axis.

In the figures, identical components are provided with identical reference signs.

### EMBODIMENT(S) OF THE INVENTION

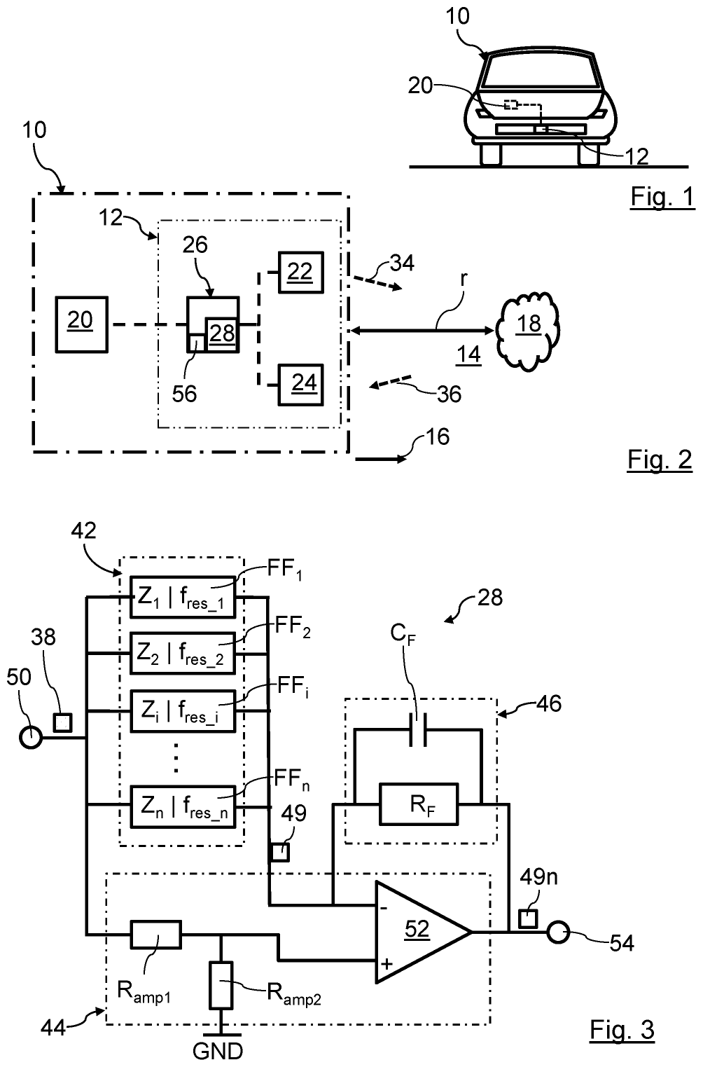

FIG. 1 shows a front view of a vehicle 10 by way of example in the form of a passenger vehicle. FIG. 2 shows a functional illustration of the vehicle 10.

The vehicle 10 has a detection device, shown by way of example in the form of a LiDAR system 12. By way of example, the LiDAR system 12 is arranged in the front fender of the vehicle 10. The LiDAR system 12 may be used to monitor a monitored region 14 in front of the vehicle 10 in the direction of travel 16 for the presence of objects 18. The LiDAR system 12 can also be arranged and oriented differently at another location on the vehicle 10. Using the measurement system 12, for example distances r, directions and speeds of objects 18 relative to the vehicle 10, or to the LiDAR system 12, can be determined. For example, the directions of objects can be specified as azimuth and/or elevation.

The objects 18 may be stationary or moving objects, for example other vehicles, persons, animals, plants, obstacles, road unevennesses, for example potholes or rocks, road boundaries, road signs, open spaces, for example parking spaces, precipitation or the like.

The LiDAR system 12 is designed by way of example as a frequency-modulated continuous-wave LiDAR system. Frequency-modulated continuous wave LiDAR systems are also referred to in specialist circles as FMCW-LiDAR systems.

The LiDAR system 12 is connected to a driver assistance system 20. The driver assistance system 20 can be used to operate the vehicle 10 autonomously or semiautonomously.

The LiDAR system 12 comprises a transmitting device 22, a receiving device 24, and a control and evaluation device 26. The control and evaluation device 26 comprises a received-signal processing apparatus 28. The received-signal processing apparatus 28 is shown in detail in FIG. 3.

The functions of the control and evaluation device 26 can be arranged centrally or in decentralized form. Parts of the functions of the control and evaluation device 26 can also be integrated in the transmitting device 22 or the receiving device 24.

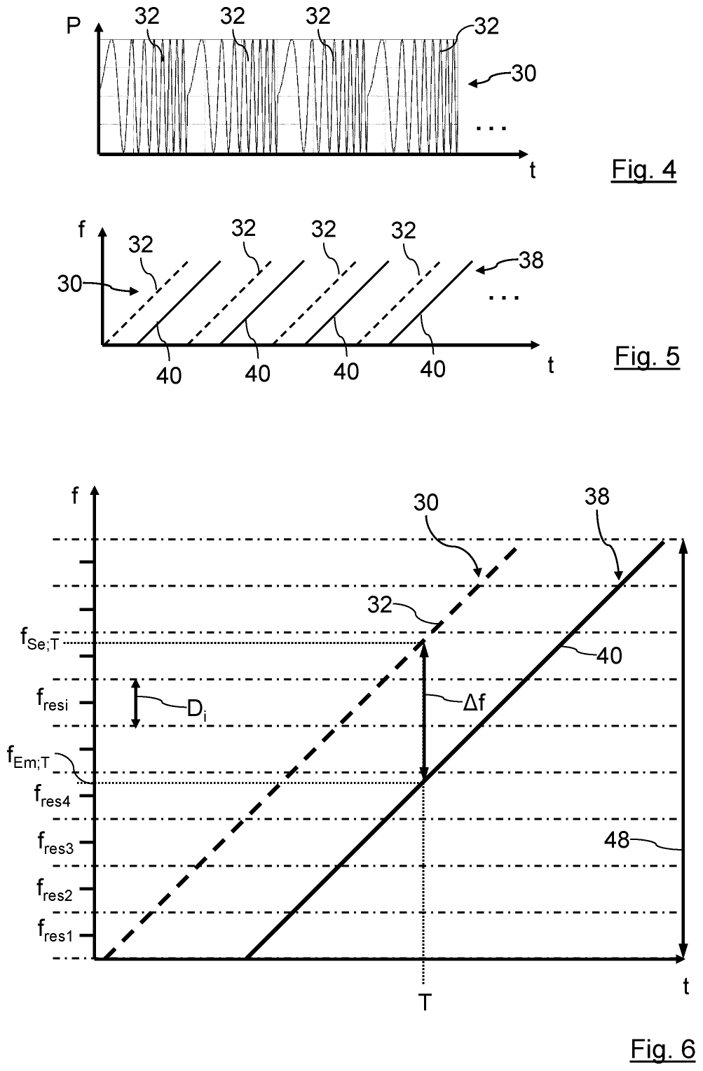

The control and evaluation device 26 can be used to generate electrical transmitted signals 30, such as a frequency-modulated continuous wave signal shown in FIG. 4. FIG. 4 shows the exemplary transmitted signal 30 in a power-time diagram. The electrical transmitted signal 30 comprises a plurality of consecutive transmitted sequences in the form of transmitted chirps 32.

In FIG. 5, the transmitted chirps 32 of the electrical transmitted signal 30 are shown dashed and, for comparison, the received chirps 40 of a corresponding electrical received signal 38, explained below, are shown in a frequency-time diagram. The transmitted chirps 32 and the received chirps 40 each have the form of frequency ramps in the frequency-time diagram. FIG. 6 shows in magnification the frequency-time diagram of one of the transmitted chirps 32 with the corresponding received chirp 40.

The transmitting device 22 can be controlled with the electrical transmitted signals 30, so that the device sends corresponding electromagnetic scanning signals 34 in the form of light signals into the monitoring region 14. The transmitting device 22 may have, for example, one or more lasers as a light source. In addition, the transmitting device 22 may optionally have a signal deflecting device, with which the scanning signal 34 is accordingly directed into the monitoring region 14.

The scanning signals 34 reflected at an object 18 in the direction of the receiving device 24 can be received with the receiving device 24 as electromagnetic echo signals 36.

The receiving device 24 may optionally have an echo-signal deflecting device, with which the electromagnetic echo signals 36 are directed to a receiver of the receiving device 24. The receiver may be, for example, detectors, for example, point sensors, line sensors and/or area sensors, in particular (avalanche) photodiodes, photodiode lines, CCD sensors, active pixel sensors, in particular CMOS sensors, or the like. Alternatively, a plurality of receivers can also be provided.

Using the receiver, the electromagnetic echo signal 36 can be converted into the electrical received signal 38, which is shown in FIGS. 5 and 6.

The received chirps 40 are delayed relative to the respective transmitted chirps 32. The time delay characterizes the time of flight between the emission of the electromagnetic scanning signal 34 and the reception of the electromagnetic echo signal 36. The time of flight is proportional to the distance r of the object 18 relative to the LiDAR system 12.

From a frequency difference Δf between the frequency ramp of the transmitted chirp 32 and the frequency ramp of the corresponding received chirp 40, the distance r can be determined. To do this, it is necessary to analyze the frequency of the received signal 38. The frequency analysis of the received signal 38 is carried out with the received signal processing apparatus 28.

The received-signal processing apparatus 28 comprises, as shown in FIG. 3, a frequency filter arrangement 42, a normalization means 44, and an optional delay means 46.

The frequency filter arrangement 42 comprises a number n of frequency filters FFᵢ. The index i, which identifies the frequency filters, ranges between 1 and the number n of frequency filters. The frequency filters FFᵢ are functionally connected in parallel.

The frequency filters FFᵢ are designed, for example, as bandpass filters in the form of resonant circuits. Each frequency filter FFᵢ has an individual resonance frequency f_{res_i} and an individual frequency passband Dᵢ. The frequency passbands Dᵢ and the resonance frequencies f_{res_i} of the frequency filters FFᵢ are shown in the frequency-time diagram in FIG. 6. The frequency filters FFᵢ are designed in such a way that their frequency passbands Dᵢ are adjacent to each other. Overall, the frequency passbands Dᵢ of all frequency filters FFᵢ are distributed without gaps over the entire frequency range 48 of the electrical transmitted signals 30 and the electrical received signals 38. The frequency passbands Dᵢ of adjacent frequency filters FFᵢ with respect to their resonance frequency f_{res_i} can partially overlap.

In addition, each frequency filter FFᵢ has an individual gain Zᵢ. With the respective individual gain Zᵢ, a received signal 49 passed through the corresponding frequency filter FFᵢ is individually amplified. The individual gain Zᵢ is used as a labeling means, with which the passed received signal 49 is labeled with a corresponding frequency feature, namely the individual degree of gain. Via the frequency feature, namely the degree of gain, the individually amplified, passed received signal 49 can be assigned to the respective frequency filter FFᵢ and thus its resonance frequency f_{res_i} and passband Dᵢ.

The inputs of the frequency filters FFᵢ are connected to an input 50 of the received-signal processing apparatus 28. The electrical received signal 38 determined with the received device 24 is present at the input 50.

The normalization means 44 comprises an operational amplifier 52 and two amplifier resistors Rₐₘₚ₁ and Rₐₘₚ₂. A minus input of the operational amplifier 52 is connected to the outputs of the frequency filters FFᵢ. A plus input of the operational amplifier 52 is connected via the amplifier resistor Rₐₘₚ₁ to the input 50 of the received-signal processing apparatus 28 and to the inputs of the frequency filters FFᵢ. The second amplifier resistor Rₐₘₚ₂ connects the plus input of the operational amplifier 52 to ground GND.

The normalization means 44 is used to normalize the strength of the passed received signal 49 present at the outputs of the frequency filters FFᵢ, based on the strength of the electrical received signal 38 present at the input 50. The received signal 38 is directly subtracted from the passed received signal 49.

The normalized, passed received signal 49n is present at the output of the operational amplifier 52. Normalizing the passed received signal 49 compensates a dependence of the strength of the received signal 38 on the distance r of the object 18.

The optional delay means 46 comprises a capacitor C_{F} with a resistor RF connected in parallel. The input of the delay means 46 is connected to the minus input of the operational amplifier 52. The output of the delay means 46 is connected to the output of the operational amplifier 52. The delay means 46 causes a feedback of the normalized, passed received signal 49n at the output of the operational amplifier 52 to the minus input. By means of the delay means 46, the normalized, passed received signal 49n is delayed. The delayed, normalized passed received signal 49n appears at the output 54 of the received signal processing apparatus 28.

The delay enables a more energy-efficient further processing of the normalized, passed received signal 49n, for example, with an analog-to-digital converter 56, which is connected to the output 54 of the received-signal processing apparatus 28. The delay enables multiplexing and digitization to be performed with bandwidths in the kilohertz range.

In order to determine the frequency difference Δf between the electrical transmitted signals 30 and the electrical received signal 38, for example using the control and evaluation device 26, the frequency f_{Em;T} of the electrical received signal 38 is determined at an example time T via the frequency feature of the normalized, passed received signal 49n, namely the degree of gain, and subtracted from the frequency f_{Se,T} of the transmitted signal 30 at the same time T. If, as shown in FIG. 6, the frequency f_{Em;T} of the electrical received signal 38 at the time T is in the frequency passband D₄ of the fourth frequency filter FF₄, then for the calculation of the frequency difference Δf, for example, the resonance frequency fᵣₑₛ₄ of the fourth frequency filter FF₄ can be taken.

From the frequency difference Δf, the distance r and, if applicable, the speed of the object 18 relative to the LiDAR system 12, i.e. relative to the vehicle 10, is determined using the control and evaluation device 26. The distance r, if applicable the speed and the direction, which are determined with the LiDAR system 12, are transmitted to the driver assistance system 20. The distance r, if applicable the speed and the direction, are used with the driver assistance system 20 for the autonomous or partially autonomous operation of the vehicle 10.

1. A received-signal processing apparatus of a detection device for monitoring at least one monitoring region for objects by electromagnetic scanning signals, the received-signal processing apparatus comprising:
at least one frequency analysis means for the frequency analysis of electromagnetic received signals, which are determined from echo signals of electromagnetic scanning signals reflected in at least one monitoring region; and
a plurality of functionally parallel frequency filters with at least partially different frequency passbands,
wherein at least one frequency filter has at least one frequency labeling means, by which a passed received signal that is passed through said at least one frequency filter is labeled with a frequency feature that characterizes the frequency passband of the at least one frequency filter that passes it.

2. The received-signal processing apparatus as claimed in claim 1, wherein a frequency filter is a bandpass filter.

3. The received-signal processing apparatus as claimed in claim 1, wherein the frequency passbands of at least two frequency filters adjacent in frequency at least partially overlap and/or the frequency passbands of at least two frequency filters adjacent in frequency do not overlap.

4. The received-signal processing apparatus as claimed in claim 1, wherein the frequency passbands of the frequency filters in total cover the maximum frequency amplitude of the electrical received signals.

5. The received-signal processing apparatus as claimed in claim 1, wherein at least two frequency filters have frequency passbands with the same frequency range and/or at least two frequency filters have frequency passbands with different frequency ranges.

6. The received-signal processing apparatus as claimed in claim 1, wherein at least one of the frequency filters has an individually defined electrical gain as a frequency labeling means.

7. The received-signal processing apparatus as claimed in claim 1, wherein the received-signal processing apparatus has at least one normalization means for normalizing received signals.

8. The received-signal processing apparatus as claimed in claim 7, wherein at least one normalization means has at least one amplification stage.

9. The received-signal processing apparatus as claimed in claim 7, wherein at least one normalization means of the received-signal processing apparatus has at least one operational amplifier, of which one of the inputs (−) is connected to the outputs of the frequency filters and another of the inputs (+) is connected to the inputs of the frequency filters.

10. The received-signal processing apparatus as claimed in claim 9, wherein at least one resistor arrangement is arranged between an input (+) of at least one operational amplifier of a normalization means of the received-signal processing apparatus and the inputs of the frequency filters.

11. The received-signal processing apparatus as claimed in claim 1, wherein the received-signal processing apparatus has at least one delay means, which is directly or indirectly connected to the outputs of the frequency filters and/or which is directly or indirectly connected to at least one input (−) of at least one normalization means of the received-signal processing apparatus.

12. The received-signal processing apparatus as claimed in claim 1, wherein at least one delay means of the at least one received-signal processing apparatus has at least one electrical capacitance.

13. The received-signal processing apparatus as claimed in claim 1, wherein at least one delay means of the received-signal processing apparatus is functionally arranged between at least one input (−) and at least one output of the at least one normalization means of the received-signal processing apparatus.

14. A detection device for monitoring at least one monitoring region for objects by electromagnetic scanning signals, the detection device comprising:
at least one transmitting device, by which electromagnetic scanning signals generated from electrical transmitted signals, wherein said scanning signals are transmitted into at least one monitoring region;
at least one receiving device by which electrical received signals are determined from echo signals of at least one scanning signal reflected in at least one monitoring region; and
at least one control and evaluation device, which comprises at least one frequency analyzer for the frequency analysis of the electrical received signals,
wherein at least one received-signal processing apparatus has a plurality of functionally parallel frequency filters with at least partially different frequency passbands and at least one frequency filter (FFᵢ) has at least one frequency labeling means, by which the passed received signal that is passed through said at least one frequency filter is labeled with a frequency feature that characterizes the frequency passband of the at least one frequency filter that passes it.
